(19) United States
(12) Patent Application Publication
(10) Pub. No.: US 2015/0002860 A1
(43) Pub. Date: Jan. 1, 2015

(54) PRINTING METHOD USING SIZE OF OBJECT, AND IMAGE FORMING APPARATUS AND SYSTEM USING THE METHOD

(71) Applicant: Samsung Electronics Co., Ltd., Suwon-si (KR)

(72) Inventors: Chang-seok CHOI, Suwon-si (KR); Seung-soo OAK, Seongnam-si (KR)

(73) Assignee: Samsung Electronics Co., Ltd., Suwon-si (KR)

(21) Appl. No.: 14/312,046

(22) Filed: Jun. 23, 2014

(30) Foreign Application Priority Data
Jun. 27, 2013 (KR) 10-2013-0074916

(51) Int. Cl. G06K 15/02

(52) U.S. Cl. CPC G06K 15/1807
USPC 358/1.2

(57) ABSTRACT

Provided are a printing method using a size of an object, in which information regarding an input size of an object included in an image is received and the image including the object is down/up-scaled and printed in consideration of a ratio between the input size and a size of the object in the displayed image, and an image forming apparatus and system using the printing method.

### CROSS-REFERENCE TO RELATED APPLICATIONS

This application claims the priority benefit of Korean Patent Application No. 10-2013-0074916, filed on Jun. 27, 2013, in the Korean Intellectual Property Office, the disclosure of which is incorporated herein in its entirety by reference.

### BACKGROUND

1. Field

One or more embodiments relate to a printing method using the size of an object, and an image forming apparatus and system using the method.

2. Description of the Related Art

An image forming apparatus, such as a printer and a multi-functional peripheral device, is capable of performing ‘push’ or ‘pull’ printing by communicating with an external electronic device. Thus, the image forming apparatus is capable of printing an image transmitted thereto.

As the specifications of an electronic device, such as a smartphone or a personal computer (PC), have increased, a user interface of the electronic device has also been developed. However, an actual size of an object included in an image displayed on a display unit of the electronic device may be difficult to predict only based on the displayed image. Thus, an image transmitted to an image forming apparatus needs to be printed while reflecting a desired size or actual size of an object included in the image.

### SUMMARY

One or more embodiments of the present disclosure include a printing method using the size of an object, in which an image is up/down-scaled and printed using the size of an object included therein, and an image forming apparatus and system using the method. Embodiments of the present disclosure are not, however, limited thereto and other various embodiments may be further derived from exemplary embodiments in the present disclosure.

In an aspect of one or more embodiments, there is provided a printing method using the size of an object which includes displaying an image; receiving information regarding an input size of an object included in the displayed image; determining a ratio between the input size and a size of the object in the displayed image; and printing the image including the object that is down-scaled or up-scaled according to the determined ratio.

In an aspect of one or more embodiments, there is provided an image forming system which includes an electronic device and an image forming apparatus capable of communicating with the electronic device. The electronic device is configured to display an image, receive information regarding an input size of an object included in the displayed image, and determine a ratio between the input size and a size of the object included in the displayed image, and the image forming apparatus is configured to print the image including the object that is down-scaled or up-scaled according to the determined ratio.

In an aspect of one or more embodiments, there is provided an image forming apparatus which is capable of communicating with an electronic device includes a network interface for receiving image data, which is obtained by rendering an image including an object by down-scaling or up-scaling the image according to a ratio between an input size and a size of the object included in the image, from the electronic device, wherein the image is displayed on the electronic device; and a print engine for printing the image including the object, based on the image data.

In an aspect of one or more embodiments, there is provided a determining a ratio between an inputted size of an object and a size of an object in the displayed image of a display, and printing the image including the object that is down-scaled or up-scaled according to the determined ratio using an image forming apparatus.

In an aspect of one or more embodiments, there is provided at least one non-transitory computer readable medium storing computer readable instructions to implement methods of one or more embodiments.

### BRIEF DESCRIPTION OF THE DRAWINGS

These and/or other aspects will become apparent and more readily appreciated from the following description of embodiments, taken in conjunction with the accompanying drawings in which:

FIG. 1 is a diagram illustrating an image forming system including an electronic device and an image forming apparatus capable of communicating with the electronic device, according to one or more embodiments.

FIG. 2 is a diagram illustrating a whole process of printing an image transmitted from an electronic device by using an image forming apparatus, according to one or more embodiments;

FIG. 3 is a block diagram of an electronic device according to one or more embodiments;

FIG. 4 is a diagram of a process of receiving information regarding an input size of an object included in an image displayed on the electronic device, according to one or more embodiments;

FIG. 5 is a diagram of a result of receiving information regarding an input size of an object included in an image displayed on the electronic device, according to one or more embodiments;

FIG. 6 is a block diagram of an image forming apparatus according to one or more embodiments;

FIG. 7 is a diagram illustrating a result of printing an image including a down-scaled object;

FIG. 8 is a diagram illustrating a result of printing an image including an up-scaled object;

FIG. 9 is a flowchart of a printing method using the size of an object, according to one or more embodiments;

FIG. 10 is a detailed flowchart of a process of receiving information regarding an input size of an object included in a displayed image, according to one or more embodiments;

FIG. 11 is a detailed flowchart of a process of determining a ratio between an input size and the size of an object included in a displayed object, according to one or more embodiments;

FIG. 12 particularly illustrates an example of a process of determining a ratio between an input size and the size of an object included in a displayed image, according to one or more embodiments; and

FIG. 13 is a detailed flowchart of a process of printing an image including an up/down-scaled object, according to one or more embodiments.

### DETAILED DESCRIPTION

Reference will now be made in detail to embodiments, examples of which are illustrated in the accompanying drawings, wherein like reference numerals refer to like elements throughout. In this regard, embodiments may have different forms and should not be construed as being limited to the descriptions set forth herein. Accordingly, embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Embodiments set forth herein relate to a printing method using the size of an object and an image forming apparatus and system using the printing method. Herein, matters that are well known to those of ordinary skill to which these embodiments pertain will not be described here in detail.

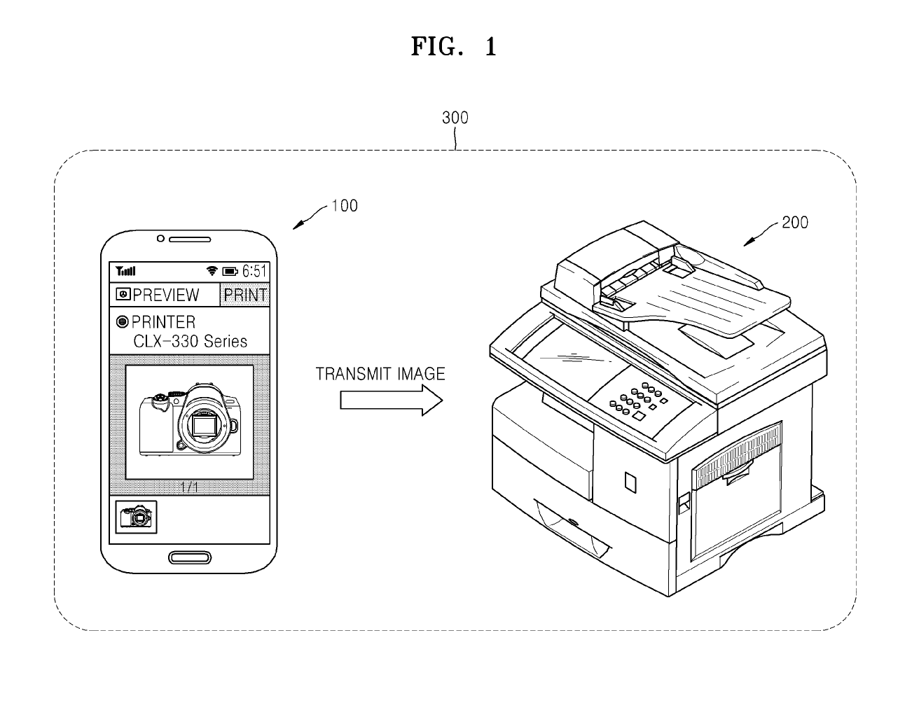

FIG. 1 is a diagram illustrating an image forming system 300 including an electronic device 100 and an image forming apparatus 200 capable of communicating with the electronic device 100, according to one or more embodiments. As illustrated in FIG. 1, the image forming system 300 according to one or more embodiments may include the electronic device 100 and the image forming apparatus 200.

The electronic device 100 and the image forming apparatus 200 may communicate with each other. The image forming apparatus 200 may communicate with a plurality of electronic devices 100. The image forming apparatus 200 may communicate with the electronic device 100 in a wired/wireless manner. For example, the image forming apparatus 200 may communicate with the electronic device 100 in any of various communication manners, such as near field communication (NFC), Wi-Fi, Zigbee, Bluetooth, Wi-Fi direct, etc. The image forming apparatus 200 may exchange data with the electronic device 100 in any of various communication manners described above.

The electronic device 100 may be a personal computer (PC), a mobile device, etc. The electronic device 100 may include a display unit (display) configured to display an image thereon. For example, the display unit may be a touch screen. Thus, an image displayed on the display unit, such as a touch screen, may be transmitted to the image forming apparatus 200.

The image forming apparatus 200 may receive data transmitted from the electronic device 100. The image forming apparatus 200 according to one or more embodiments may be any of various types of image forming apparatuses, such as a printer, a multi-functional peripheral device, a scanner, etc.

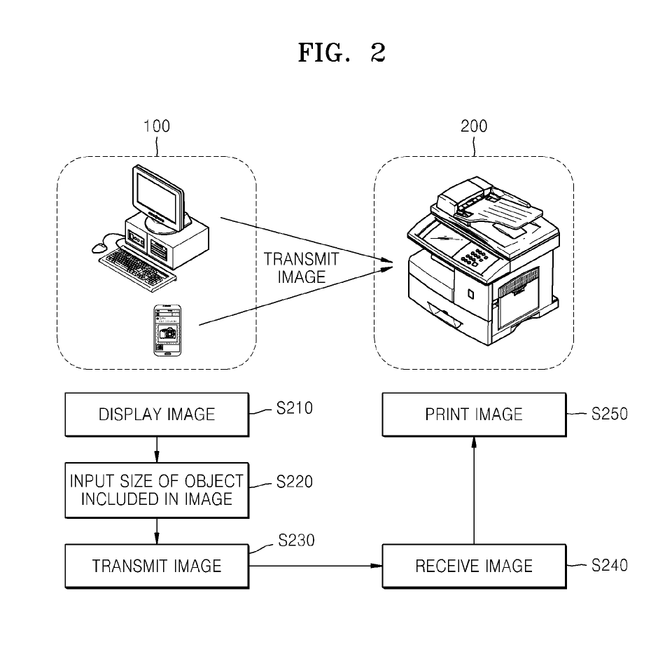

FIG. 2 is a diagram illustrating a whole process of printing an image transmitted from an electronic device by using an image forming apparatus, according to one or more embodiments As described above with reference to FIG. 1, the image forming apparatus 200 may exchange data with the electronic device 100 by communicating with the electronic device 100. The image forming apparatus 200 according to one or more embodiments may receive image data to be printed from the electronic device 100.

FIG. 2 illustrates a whole process in which the electronic device 100 transmits the image data to the image forming apparatus 200 and the image forming apparatus 200 receives the image data and prints an image corresponding to the image data, according to one or more embodiments.

Specifically, the electronic device 100 may display an image that a user desires to view, on the display unit of the electronic device 100 (operation S210). The user may view and print the image displayed on the display unit. In one or more embodiments, the user may input a size of an object included in the image (operation S220) displayed on the display unit so that the object may be printed in a desired size or in the actual size thereof. For example, when the display unit is a touch screen type display, the user may input the size of the object by designating a desired region of the image displayed on the touch screen and inputting the size of the designated region in the form of numbers. The electronic device 100 determines whether the image including the object is to be up-scaled or down-scaled, based on the input size of the object. The image including the up/down-scaled object is transmitted from the electronic device 100 to the image forming apparatus 200 (operation S230). The image forming apparatus 200 may receive the image from the electronic device 100 (operation (S240) and print the received image (operation S250).

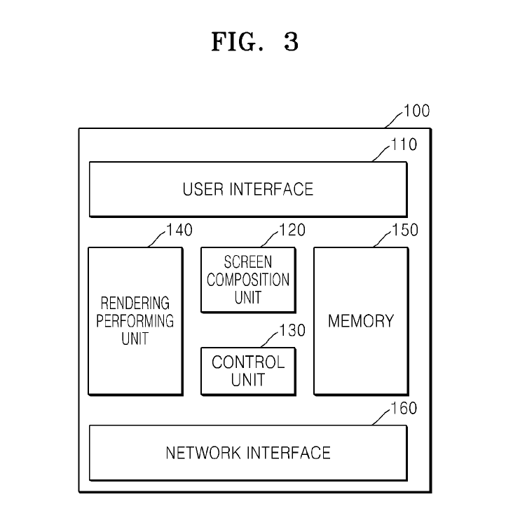

FIG. 3 is a block diagram of an electronic device 100 according to one or more embodiments. The electronic device 100 may include a user interface 110, a screen composition unit (screen composer) 120, a control unit (controller) 130, a rendering performing unit (rendering performer) 140, a memory 150, and a network interface 160. It would be apparent to those of ordinary skill in the technical field to which the current embodiment pertains that the electronic device 100 may further include other general elements in addition to the elements shown in FIG. 3.

The user interface 110 is an input/output (I/O) unit via which an input is received from a user of the electronic device 100 or information is displayed to the user. For example, the user interface 110 may be a touch panel, which is an electrostatic/piezoelectric touch screen type display configured to display an input by the user and information together; or a device in which a display unit (e.g., an active matrix organic light-emitting diode (AMOLED) display or a liquid crystal display (LCD)) and an input unit (e.g., a touch pad or buttons) are separately installed. Hereinafter, it is assumed for convenience of explanation that the user interface 110 includes a touch screen and a plurality of buttons.

For example, when the user interface 110 is a touch screen type display, a user may input the size of an object included in an image displayed on the touch screen by designating a desired region of the image displayed on the touch screen and then inputting the size of the designated region in the form of numbers via the touch screen or buttons thereof. The inputting of the size of the object may include inputting a size detected by searching for text regarding the object or searching for images based on the image. Also, the user may select the size of paper on which the image is to be printed by using the touch screen or the buttons.

The screen composition unit 120 creates a screen image to be displayed on the user interface 110, and senses a user input received via the user interface 120. The screen composition unit 120 creates the screen image to be displayed on the user interface 110, based on data rendered by the rendering performing unit 140. Also, a user checks information received via the user interface 110. Information input by the user as described above is transmitted to the control unit 130 so that the control unit 130 may control the electronic device 100. However, when the user interface 110 does not employ a manner in which an input and an output are simultaneously made as in a touch screen, the screen composition unit 120 may only create a screen image to be displayed on the user interface 110.

The control unit 130 controls overall operations of the electronic device 100. When a user inputs information via the user interface 110, the screen composition unit 120 checks the input information and transmits the input information to the control unit 130, and the control unit 130 controls the electronic device 100 based on this information. According to one or more embodiments, the control unit 130 determines whether an image including an object and displayed on the user interface 110 is to be up-scaled or down-scaled, based on an input size of the object. For example, the input size of the object included in the displayed image is provided via the user interface 110, the ratio between the input size and the size of the object included in the displayed image is determined, and whether the image including the object is to be up-scaled or down-scaled is determined based on the determined ratio

More specifically, a desired region of the object included in the image displayed on the user interface 110 is designated and information regarding the size of the designated region is obtained to receive information regarding the size of the object. The control unit 130 may obtain information regarding a display ratio between the designated region and paper on which the image displayed on the user interface 110 is to be printed, and calculate the size of the object in the displayed image using the display ratio. In other words, when the display ratio between the designated region and the paper on which the displayed image is to be printed is determined, the size of the object to be displayed with respect to the designated region may be calculated since the size of the paper is predetermined according to standards. Thus, the ratio between the input size and the size of the object in the displayed image may be determined and the image including the object may be down-scaled or up-scaled based on the determined ratio. For example, when the ratio between the input size and the size of the object in the displayed image is less than ‘1’, it indicates that the input size is less than the size of the object displayed. Thus, the image including the object is down-scaled. In contrast, when the ratio between the input size and the size of the object in the displayed image is greater than ‘1’, it indicates that the input size is greater than the size of the object displayed. Thus, the image including the object is up-scaled.

The rendering performing unit 140 performs rendering to produce an image. The rendering performing unit 140 may perform rendering to produce an image to be displayed on the user interface 110. Also, when the image including the object is determined by the control unit 130 to be down-scaled or up-scaled, the rendering performing unit 140 may produce rendered image data by down/up-scaling the displayed image. In one or more embodiments, the rendering performing unit 140 may perform rendering differently according to the usage of the rendered image data. For example, when the rendered image data is to be transmitted to the image forming apparatus 200 instead of the electronic device 100, the rendering performing unit 140 may perform rendering in the form that the image forming apparatus 200 may process.

The memory 150 stores data needed to operate the electronic device 100 or data generated when the electronic device 100 operates.

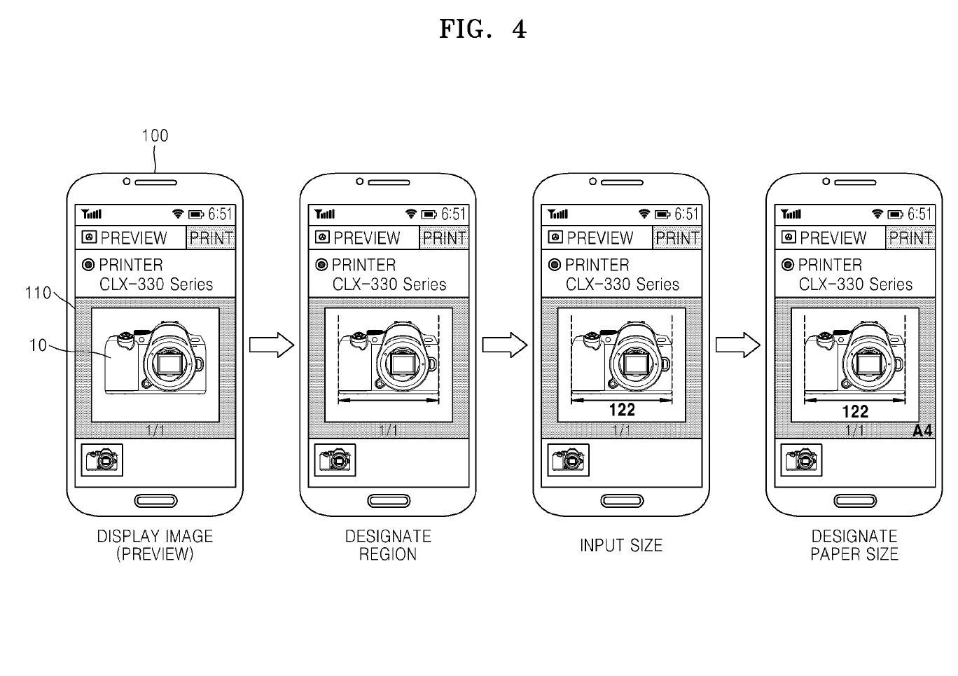

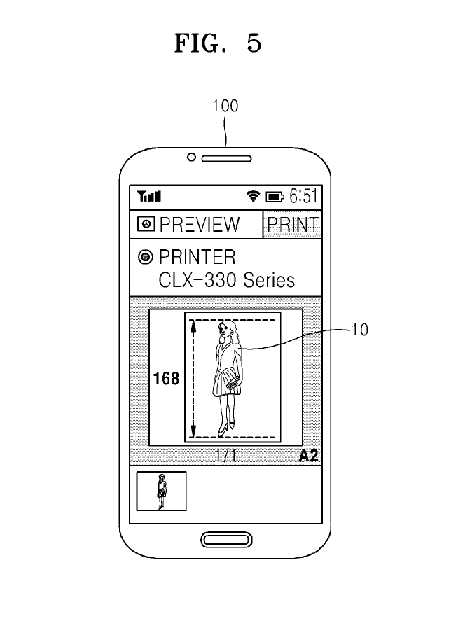

The network interface 160 is used to exchange data with the image forming apparatus 200 or a device outside the electronic device 100. An image that a user desires to print may be transmitted to the image forming apparatus 200 via the network interface 160. In one or more embodiments, image data rendered by down/up-scaling the image by the rendering performing unit 140 may be transmitted from the electronic device 100 to the image forming apparatus 200. A work that may be performed by the electronic device 100 according to one or more embodiments will now be described with reference to FIGS. 4 and 5.

FIG. 4 is a diagram of a process of receiving information regarding an input size of an object 10 included in an image displayed on the electronic device 100, according to one or more embodiments. According to one or more embodiments, the size of an object should be input to print an image including the object by using the size of the object, as described below.

The electronic device 100 includes the user interface 110 that is a touch screen type display, as a display unit capable of displaying an image thereon. A user performs the following operations, before an image displayed on the electronic device 100 is transmitted to an image forming apparatus (not shown) to be printed:

First, the image that is to be printed is displayed on the user interface 110. In one or more embodiments, the image may be displayed on the user interface 110, and the object 10 that the user desires to print in a desired size may be included in the image. That is, the image that is to be printed may be displayed in a preview mode before the image is printed.

Second, the user designates a desired region of the object 10 in the image displayed on the user interface 110.

Third, the user inputs a desired size or the actual size of the designated region.

Fourth, the size of paper on which the image is to be printed may be changed. Alternatively, the paper size may be determined as a default.

Referring to FIG. 4, a digital camera is displayed as the object 10 included in the image on the user interface 110 of the electronic device 100, a horizontal region of the digital camera in the displayed image is designated, and 122 mm is input as a numerical value corresponding to the designated horizontal region. In one or more embodiments, the size of paper on which the image is to be printed may be preset as A4, but a size of the paper may be input by the user in some cases. In particular, when the image including the object 10 is rendered by up-scaling it, paper having a larger size may be selected.

FIG. 5 is a diagram of a result of receiving information regarding an input size of an object 10 included in an image displayed on the electronic device 100, according to one or more embodiments.

Referring to FIG. 5, a woman is displayed as the object 10 included in the image displayed on the user interface 110 of the electronic device 100, a vertical region corresponding to the height of the woman in the displayed image is designated, and ‘168 cm’ is input as a numerical value corresponding to the designated vertical region. In one or more embodiments, ‘A2’ is input as the size of paper on which the image is to be printed. Referring to FIG. 5, since 168 cm is input as the size of the object 10, the image is up-scaled and printed unless the size of the object 10 in the image displayed on the electronic device 100 is 168 cm. As described above, when an image is up-scaled and printed, the size of paper on which the image is to be printed may be appropriately selected. If an entire image cannot be printed on a piece of paper, the image may be divided into several parts and the several parts of the image may be printed on a plurality of sheets of paper, respectively. When the image is divided into several parts and the several parts of the image are printed on the respective sheets of paper, portions of the several parts of the image may be redundantly printed on the edges of the respective sheets of paper, in consideration of an allowable error of an image forming apparatus (not shown). The sheets of paper on which the several parts of the image are respectively printed may be joined together such that no parts of the image are omitted using the redundantly printed portions of the several parts of the image.

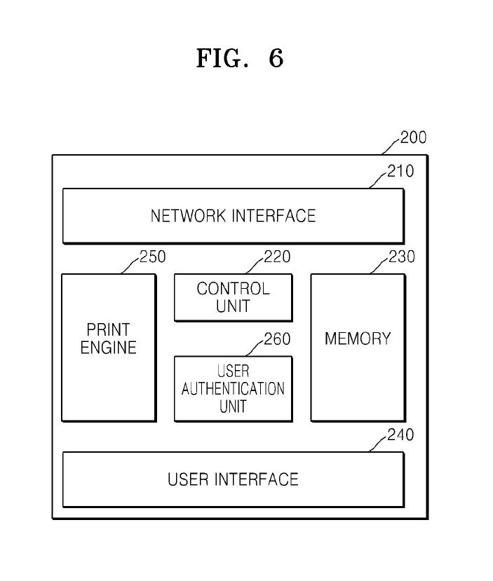

FIG. 6 is a block diagram of an image forming apparatus 200 according to one or more embodiments. The image forming apparatus 200 may include a network interface 210, a control unit 220, a memory 230, a user interface 240, a print engine 250, and a user authentication unit (user authenticator) 260. It would be apparent to those of ordinary skill in the technical field to which the current embodiment pertains that the image forming apparatus 200 may further include other general elements in addition to the elements illustrated in FIG. 6.

The network interface 210 may receive data from the electronic device 100 of FIG. 3 or outside the image forming apparatus 200. The received data may be stored in the memory 230 under control of the control unit 220. For example, the network interface 210 may receive image data rendered by up/down-scaling and rendering an image, which is displayed on the electronic device 100 and includes an object, based on the ratio between an input size and a displayed size of the object, from the electronic device 100. The input size of the object may be input from the electronic device 100 by designating a desired region of the object in the image displayed on the electronic device 100 and obtaining information regarding the size of the designated region.

The control unit 220 controls overall operations of the image forming apparatus 200. The control unit 220 may control the image forming apparatus 200 according to a user command input via the user interface 240. The control unit 220 may load an image, which is to be printed, to the memory 230, in response to the user command input via the user interface 240. In one or more embodiments, the control unit 220 may control the print engine 250 to perform printing by selecting the direction or arrangement of paper to use a minimum amount of paper, in consideration of data regarding the image to be printed. Also, when the image data rendered by up-scaling the image including the object is received from the electronic device 100, the control unit 220 may control the print engine 250 to print the image while excluding regions of the image in which the object is not included.

The memory 230 may store data received via the network interface 210. The memory 230 may store data needed to operate the electronic device 100 or data generated when the electronic device 100 operates.

The user interface 240 may receive a command to operate the image forming apparatus 200 from a user of the image forming apparatus 200. The user interface 240 may be embodied in the form of any of various forms, such as a touch panel, buttons, etc., and may be used to display information regarding an operation of the image forming apparatus 200 to the user or to receive a command from the user. For example, the user may input a command to print data stored in the memory 230 by using the touch panel or at least one of the buttons.

The user of the image forming apparatus 200 may input a command to control an operation of the image forming apparatus 200 by manipulating the user interface 240 of the image forming apparatus 200.

The print engine 250 may print print data loaded from the memory 230 under control of the control unit 220. For example, the control unit 220 may load the image data, which is received from the electronic device 100, from the memory 230, and the print engine 250 may print the loaded image data.

The user authentication unit 260 authenticates a user of the image forming apparatus 200 or a user of the electronic device 100. In general, since the image forming apparatus 200 may be used by a plurality of users, some works may require user authentication. For example, when printed matter that is to be printed by the image forming apparatus 200 is a private document that should not be available to others, a password may be set for the printed matter stored in the image forming apparatus 200 so that others cannot access the printed matter and only users who exactly input the password may access the printed matter. According to one or more embodiments, only users who are authorized to use the image forming apparatus 200 can print an image including an object, the size of which is input, based on received image data.

Although not shown in FIG. 6, the image forming apparatus 200 may further include a rendering performing unit that is substantially the same as the rendering performing unit 140 included in the electronic device 100 of FIG. 3. In one or more embodiments, not only the electronic device 100 but also the image forming apparatus 200 may perform rendering to down/up-scale an image that includes an object and that is to be printed.

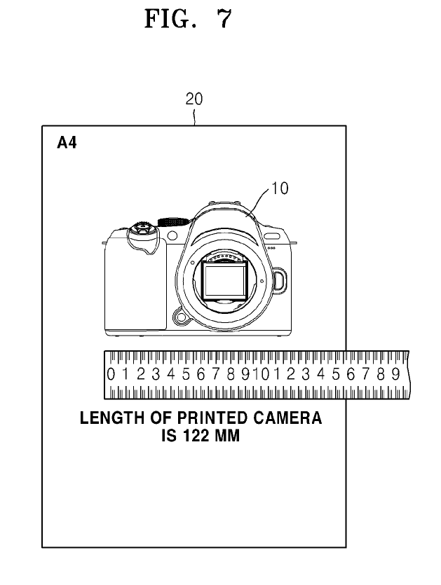

FIG. 7 is a diagram illustrating a result of printing an image including a down-scaled object. The process of inputting a size of the object 10, e.g., a digital camera, which is included in the image displayed on the user interface 110 of the electronic device 100 by designating a horizontal region of the digital camera in the displayed image and then inputting 122 mm as a numerical value corresponding to the designated horizontal region, has been described above with reference to FIG. 4. FIG. 7 is a diagram illustrating a result of printing the image by the image forming apparatus 200 according to one or more embodiments.

As illustrated in FIG. 7, since the numeral value input as the horizontal length of the digital camera is 122 mm that is sufficient to be printed on a sheet of A4 paper, the image was printed on a sheet of A4 paper based on the input size of the digital camera.

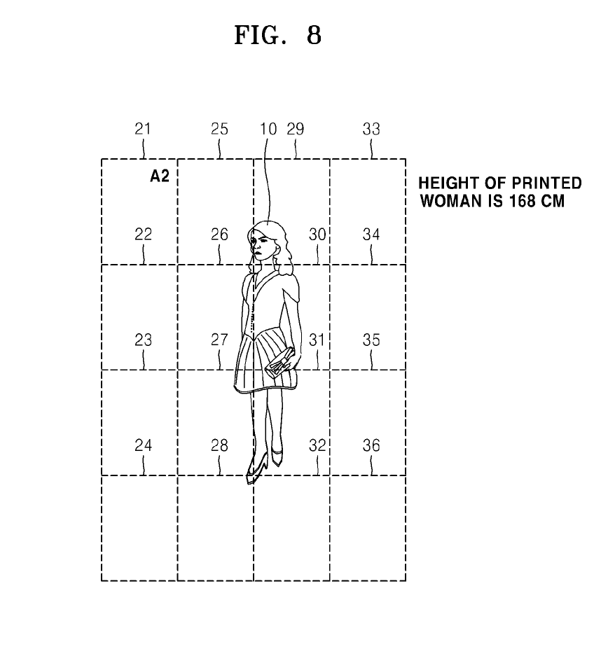

FIG. 8 is a diagram illustrating a result of printing an image including an up-scaled object. The process of inputting the size of the object 10, e.g., a woman, which is included in the image displayed on the user interface 110 of the electronic device 100 by designating a vertical region corresponding to the height of the woman in the displayed image, inputting ‘168 cm’ as a numerical value corresponding to the designated vertical region, and inputting ‘A2’ as the size of paper on which the image is to be printed, has been described above with reference to FIG. 5. FIG. 8 is a diagram illustrating a result of printing the image by the image forming apparatus 200 according to one or more embodiments.

As illustrated in FIG. 8, since the numerical value input as the vertical length corresponding to the height of the woman is 168 cm, which cannot be totally printed on a sheets of A2 paper, the image was printed on a plurality of sheets of A2 paper based on the input size input as the height of the woman (note that the size of a piece of A2 paper is 420 mm×594 mm). When the image is divided into several parts and the several parts of the image are printed on a plurality of sheets of paper, respectively, the contents of printed matter may be printed on the plurality of respective sheets of paper such that portions of the several parts of the image are redundantly printed on edges of the plurality of sheets of paper, in consideration of an allowable error of the image forming apparatus 200. Using the redundantly printed portions of the several parts of the image, the plurality of respective sheets of the paper on which the several parts of the image are printed may be joined together such that no parts of the image are omitted.

As illustrated in FIG. 8, parts of the object 10 that the user is interested in are not contained in all the plurality of sheets of A2 paper. That is, only a background included in the image, excluding the object 10, was printed on first to fourth sheets of paper 21 to 24 and thirteenth to sixteenth sheets of paper 33 to 36 among the plurality of sheets of A2 paper. Thus, in one or more embodiments, the print engine 250 may be controlled to print the image including the object 10 excluding regions of the image in which the object 10 is not included, on only fifth to twelfth sheets of paper 25 to 32.

Furthermore, the print engine 250 may be controlled to perform printing by selecting the direction or arrangement of paper to use a minimum amount of paper. For example, when the location of the object 10, which is a woman illustrated in FIG. 8, is moved to upper and right directions, i.e., when the location of the plurality of sheets of paper are slightly moved to lower and left directions, the object 10 (the woman) may be printed such that the actual size of the woman is fully included on ninth to eleventh sheets of paper 29 to 32, thereby saving thirteen sheets of A2 paper. In one or more embodiments, the fifth to eighth sheets of paper 25 to 28 and the twelfth piece of paper 32 may be saved, compared to the former case in which the direction or arrangement of paper is not selected.

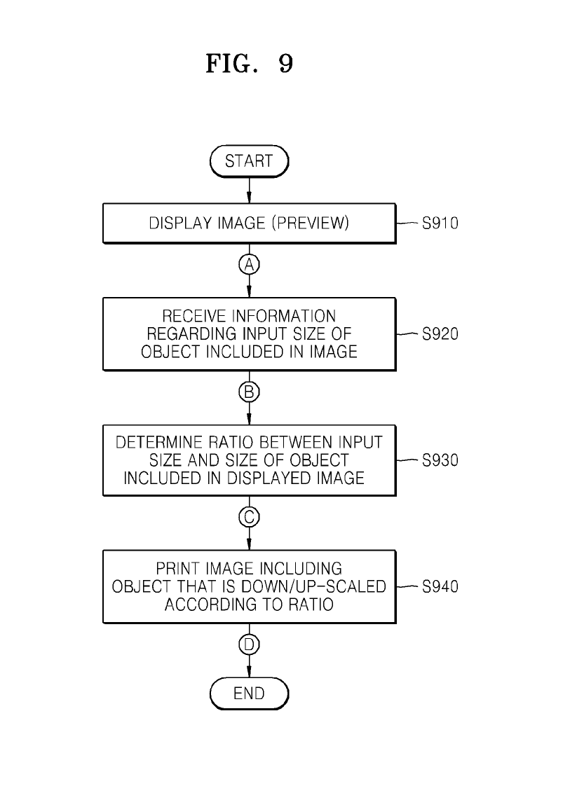

FIG. 9 is a flowchart of a printing method using the size of an object, according to one or more embodiments. Although not described here, the above descriptions of the image forming apparatus 200 and the image forming system 300 may also be applied to the printing method using the size of an object, according to the current embodiment.

Referring to FIG. 9, the electronic device 100 displays an image to be printed thereon (operation S910).

Then, a size of an object included in the image is input to the electronic device 100 (operation S920). The inputting of the size of the object will be described in detail with reference to FIG. 10 below.

FIG. 10 is a detailed flowchart of a process of receiving information regarding a size of an object included in a displayed image, according to one or more embodiments.

A desired region of the object included in the display image is designated using the user interface 110 of the electronic device 100 (operation S1010).

Then, the size of the designated region is input to the electronic device 100 (operation S1020).

For example, a desired size or an actual size of the designated region may be directly input via the user interface 110 of the electronic device 100. As another example, a size detected by searching for text regarding the object or searching for images based on the image may be input as the size of the designated region. That is, when text is searched for based on a specific model name of a digital camera, the size of the object may be input by extracting and receiving information corresponding to the size of the digital camera among information representing data of the specific model.

Then, the size of paper on which the displayed image is to be printed is designated using the user interface 110 of the electronic device 100 (operation S1030). A user may select an appropriate size of paper as paper on which the displayed image is to be printed. Since the paper size may be determined as a default size, the paper size determined as the default size may be designated as the size of paper on which the displayed image is to be printed, unless the user designates a specific size of paper.

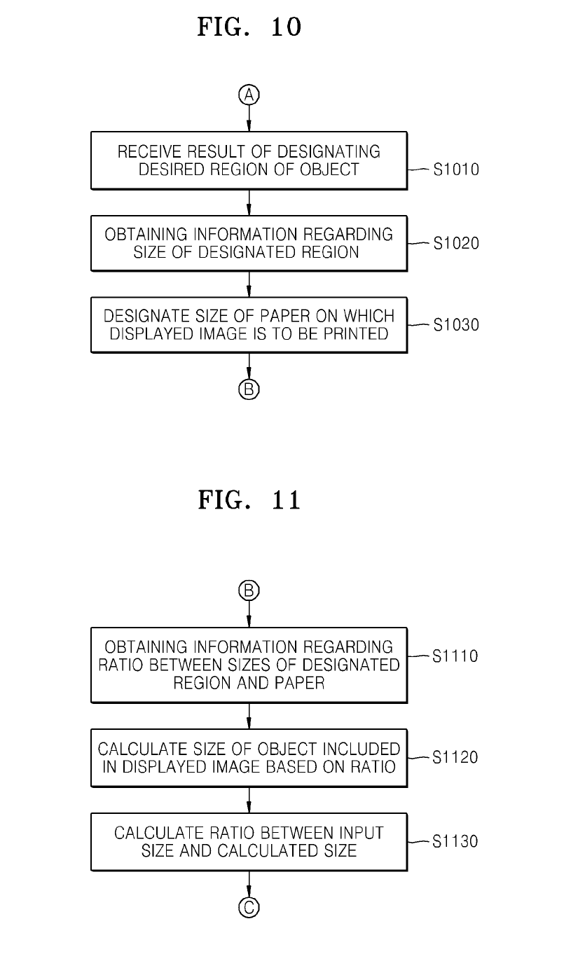

Referring back to FIG. 9, the electronic device 100 determines the ratio between the input size and the size of the object included in the displayed image (operation S930). A process of determining the ratio between the input size and the size of the object included in the displayed image will be described in detail with reference to FIG. 11 below.

FIG. 11 is a detailed flowchart of a process of determining the ratio between the input size and the size of the object included in a displayed object, according to one or more embodiments.

Referring to FIG. 11, the control unit 130 of the electronic device 100 obtains information regarding a display ratio between sizes of a region of the object designated by a user and paper on which an image is to be printed, from a user via the user interface 110 (operation S1110). That is, the display ratio between the designated region and the vertical or horizontal length of paper to be compared with the size of the designated region is obtained.

Then, the control unit 130 of the electronic device 100 calculates the displayed size of the object included in the displayed image based on the display ratio (operation S1120). That is, when the display ratio between the designated region and the paper is determined, the displayed size of the object with respect to the designated region may be calculated since the size of paper is preset according to standards.

Then, the control unit 130 of the electronic device 100 determines a ratio between an input size and the calculated size with respect to a desired region of the object (operation S1130). The image including the object may be down-scaled or up-scaled according to the determined ratio. For example, the ratio between the input size and the calculated size is less than ‘1’ indicates that the input size is less than the display size and the image including the object is thus down-scaled. In contrast, the ratio between the input size and the calculated size is greater than ‘1’ indicates that the input size is greater than the display size and the image including the object is thus up-scaled.

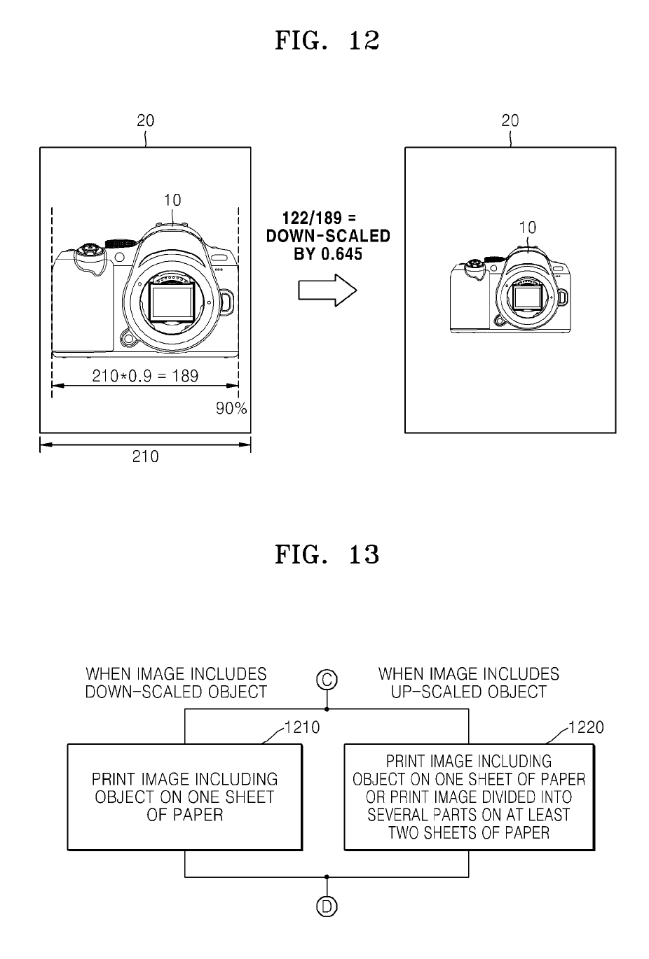

FIG. 12 particularly illustrates a case in which a ratio between an input size and the size of an object included in a displayed image is determined. Referring to FIG. 12, the control unit 130 of the electronic device 100 obtains information regarding the display ratio between a designated region of the object and paper on which the image is to be printed, and calculates the size of the object in the displayed image based on the obtained ratio. Then, the control unit 130 of the electronic device 100 determines a ratio between the input size and the calculated size with respect to a desired region of the object included in the displayed image.

In FIG. 12, it is assumed that the paper on which the image is to be printed is A4 paper, the horizontal and vertical lengths of which are 210 mm×297 mm. Referring to FIG. 12, the region designated by the user corresponds to the horizontal length of a digital camera 10. In one or more embodiments, the ratio between the length of the region designated by the user and the horizontal length of the A4 paper 20 on which the image is to be printed is calculated. In FIG. 12, it is assumed that, for convenience of explanation, the calculated ratio is 90%, i.e., ‘0.9’. In one or more embodiments, since the horizontal length of the A4 paper 20 has been determined to be 210 mm according to standards, the size of the object 10 in the displayed image may be calculated by multiplying the horizontal length of the A4 paper 20 by the calculated ratio. That is, the size of the object 10 included in the displayed image is calculated to be 189 mm by multiplying 210 mm by 0.9. In one or more embodiments, when the user inputs ‘122 mm’ as the size of the designated region by obtaining information regarding the horizontal length of the digital camera 10, the size of the designated region is less than the size of the object 10 in the displayed image, i.e., 189 mm. A ratio between the input size and the calculated size of the object 10 in the displayed image may be determined to be 122/189=0.645. Since the ratio between the input size and the calculated size of the object 10 in the displayed image is less than ‘1’, the image including the object 10 should be down-scaled. Thus, the digital camera 10 is actually down-scaled by 0.645 and printed on the A4 paper, as illustrated in a right part of FIG. 12.

Referring back to FIG. 9, the image forming apparatus 200 prints the image including the object that is down/up-scaled according to the determined ratio (operation S940). A process of printing an image including an up/down-scaled object will be described in detail with reference to FIG. 13 below.

FIG. 13 is a detailed flowchart of a process of printing an image including an up/down-scaled object, according to one or more embodiments. A printing method may vary according to whether an image includes a down-scaled object or an up-scaled object.

First, when an image includes a down-scaled object, an input size of the object is less than the paper size. Thus, the image including the object may be printed only on one sheet of paper.

When the image includes an up-scaled object, the image may be printed on at least two sheets of paper, although there is a case in which the image may be printed only on one sheet of paper. In one or more embodiments, the print engine 250 of FIG. 6 may be controlled to print the image including the object while excluding regions of the image that do not include any part of the object as much as possible. Furthermore, the print engine 250 may be controlled to print the image by selecting the direction or arrangement of paper to use a minimum amount of paper.

As described above, according to the one or more of the above embodiments, an image including an object may be printed while reflecting a size that a user inputs with respect to the object, thereby enabling the user to realistically sense the size and design of the object included in the image.

Processes, functions, methods, and/or software in apparatuses described herein may be recorded, stored, or fixed in one or more non-transitory computer-readable storage media (computer readable recording medium) that includes program instructions (computer readable instructions) to be implemented by a computer to cause one or more processors to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of non-transitory computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions may be executed by one or more processors and/or by one or more processing elements. The described hardware devices may be configured to act as one or more software modules that are recorded, stored, or fixed in one or more computer-readable storage media, in order to perform the operations and methods described above, or vice versa. In addition, a non-transitory computer-readable storage medium may be distributed among computer systems connected through a network and computer-readable codes or program instructions may be stored and executed in a decentralized manner. In addition, the computer-readable storage media may also be embodied in at least one application specific integrated circuit (ASIC) or Field Programmable Gate Array (FPGA).

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present disclosure have been described with reference to the figures, it will be understood by those of ordinary skill in the art that various changes in form and details may be made therein without departing from the spirit and scope of the present disclosure as defined by the following claims.

What is claimed is:

1. A printing method using a size of an object, the printing method comprising:
displaying an image on a display;
receiving information for an input size of the object included in the displayed image;
determining a ratio between the input size and a size of the object in the displayed image; and
printing the image including the object that is down-scaled or up-scaled according to the determined ratio using an image forming apparatus.

2. The printing method of claim 1, wherein the receiving of the information for the input size of the object comprises:
receiving a result of designating a desired region of the object; and
obtaining information for a size of the designated region.

3. The printing method of claim 2, wherein the determining of the ratio between the input size and the size of the object in the displayed image comprises:
obtaining information for a ratio between sizes of the designated region in the displayed image and paper on which the displayed image is to be printed;
calculating the size of the object in the displayed image based on the ratio; and
calculating the ratio between the input size and the calculated size.

4. The printing method of claim 1, wherein the receiving of the information for the input size of the object comprises receiving information for a size detected by searching for text for the object or searching for images by using the image.

5. The printing method of claim 1, wherein the printing of the image including the object comprises printing the image by selecting a direction or arrangement of paper in order to use a minimum amount of paper.

6. The printing method of claim 1, wherein, when the image including the object is up-scaled, the printing of the image including the object comprises printing the image while excluding regions of the image in which the object is not included.

7. An image forming system comprising an electronic device and an image forming apparatus capable of communicating with the electronic device, wherein:
the electronic device is configured to display an image, receive information for an input size of an object included in the displayed image, and determine a ratio between the input size and a size of the object included in the displayed image, and
the image forming apparatus is configured to print the image including the object that is down-scaled or up-scaled according to the determined ratio.

8. The image forming system of claim 7, wherein the electronic device receives the information for the input size of the object by receiving a result of designating a desired region of the object in the displayed image and obtaining information for a size of the designated region.

9. The image forming system of claim 8, wherein the electronic device determines the ratio between the input size and the size of the object included in the displayed image by obtaining information for a ratio between sizes of the designated region and paper on which the displayed image is to be printed, calculating the size of the object in the displayed image based on the ratio, and calculating a ratio between the input size and the calculated size.

10. The image forming system of claim 7, wherein the electronic device receives information for a size detected by searching for text for the object or searching for images by using the image as the information for the input size of the object.

11. The image forming system of claim 7, wherein the image forming apparatus prints the image by selecting a direction or arrangement of paper to use a minimum amount of paper.

12. The image forming system of claim 7, wherein, when the image including the object is up-scaled, the image forming apparatus prints the image while excluding regions of the image in which the object is not included.

13. The image forming system of claim 7, wherein one of the electronic device and the image forming apparatus performs rendering to down-scale or up-scale the image including the object according to the determined ratio.

14. An image forming apparatus capable of communicating with an electronic device, the image forming apparatus comprising:
a network interface to receive image data, which is obtained by rendering an image including an object by down-scaling or up-scaling the image according to a ratio between an input size and a size of the object included in the image, from the electronic device, wherein the image is displayed on the electronic device; and
a print engine to print the image including the object, based on the image data.

15. The image forming apparatus of claim 14, wherein the input size of the object is input by designating a desired region of the object in the displayed image and obtaining information for a size of the designated region.

16. The image forming apparatus of claim 15, wherein the ratio between the input size and the size of the object in the displayed image is determined by obtaining information for a ratio between sizes of the designated region and paper on which the displayed image is to be printed, calculating the size of the object in the displayed image based on the ratio, and calculating a ratio between the input size and the calculated size.

17. The image forming apparatus of claim 14, wherein the input size of the object is a size detected by searching for text for the object or searching for images by using the image.

18. The image forming apparatus of claim 14, further comprising a controller to control the print engine to print the image by selecting a direction or arrangement of paper to use a minimum amount of paper.

19. The image forming apparatus of claim 18, wherein, when image data obtained by rendering the image including the object by up-scaling the image is received, the controller controls the print engine to print the image while excluding regions of the image in which the object is not included

20. The image forming apparatus of claim 14, further comprising a user authenticator to authenticate a user of the electronic device based on user information, wherein, when the user authenticates, the print engine prints the image including the object, based on the image data.

21. At least one non-transitory computer readable medium storing computer readable instructions, which when executed, controls at least one processor to implement the method of claim 1.

22. A printing method comprising:
determining a ratio between an inputted size of an object and a size of an object in the displayed image of a display; and
printing the image including the object that is down-scaled or up-scaled according to the determined ratio using an image forming apparatus.

23. At least one non-transitory computer readable medium storing computer readable instructions, which when executed, controls at least one processor to implement the method of claim 1.
